(19) United States
(12) Patent Application Publication
(10) Pub. No.: US 2011/0123679 A1
(43) Pub. Date: May 26, 2011

(54) METHOD AND KIT FOR FLAVORING SNACKS

(76) Inventors: Michael James Leigh, Camberley (GB); PA LA SHA TI, Beijing (CN); Yongmei SUN, Beijing (CN)

(21) Appl. No.: 12/951,526

(22) Filed: Nov. 22, 2010

(30) Foreign Application Priority Data
Nov. 25, 2009 (CN) PCT/CN2009/001313

(51) Int. Cl. A23L 1/216; A23L 1/22; B65D 85/30

(52) U.S. Cl. 426/87; 426/392; 426/637

(57) ABSTRACT

A method for flavoring a shaped snack has the steps of: providing an outer package, providing a tray sealed within the outer package, providing a plurality of shaped snacks arranged in the tray, and providing a flavoring package with a flavoring therein. The method also contains the steps of opening the outer package, removing the tray from the outer package, opening the flavoring package, applying the flavoring for the flavoring package to the shaped snacks while they are in the tray, re-inserting the tray into the outer package while the shaped snacks are in the tray, and agitating the outer package to distribute the flavoring. The flavoring package may be opened at any time prior to adding the flavoring to the shaped snacks. A kit for flavoring a plurality of shaped snacks is also described.

### CROSS REFERENCE TO RELATED APPLICATION(S)

This application claims the benefit of PCT China Application No. PCT/CN2009/00 filed Nov. 25, 2009.

### FIELD OF THE INVENTION

The present invention relates to snacks. Specifically, the present invention relates to methods and kits for flavoring snacks.

### BACKGROUND OF THE INVENTION

Snacks and especially dry snacks such as cookies, crackers, crisps, chips, etc. come in a variety of shapes and packaging. Some are loosely placed in bags, while others are in canisters. In some cases, where such snacks are of a uniform shape, they are called shaped snacks, or sometimes molded snacks. In such cases, where the shape is substantially the same and/or complementary, breakage may be reduced by providing an additional tray. Such a tray may be provided in an outer container such as a bag or a canister.

Consumers sometimes desire to customize their own snacks by adding flavorings and/or additional flavorings thereto. In fact, adding flavorings to a snack in a bag is how salt was first added to bagged potato chips many decades ago. Other loose snacks, such as French fries, have been sold in a bag with separate flavoring packages which are then added to the bag and then shaken to distribute the flavorings. Such a method is relatively simple and effective, as there is often excess space within the bag and around the snack, and there is sufficient room for the snacks to be shaken, agitated, turned, etc. so as to spread the flavorings around relatively evenly.

However, it has been found that evenly adding flavorings to a plurality of shaped snacks is much more difficult, as by definition, the shaped snacks complement each other's shapes. Therefore, there is correspondingly less space between them. Thus, the shaped snacks physically prevent the flavorings, typically particulate flavorings, from evenly covering each shaped snack during a mild agitation. If more serious agitation is used, then the shaped snacks in a container will typically be subject to significantly increased breakage.

Accordingly, the need exists for a kit and a method for customizing flavorings in a plurality of shaped snacks that provides more even coverage of the shaped snacks.

### SUMMARY OF THE INVENTION

The present invention relates to a method for flavoring a shaped snack having the steps of: providing an outer package, providing a tray sealed within the outer package, providing a plurality of shaped snacks arranged in the tray, and providing a flavoring package with a flavoring therein. The method also contains the steps of opening the outer package, removing the tray from the outer package, opening the flavoring package, applying the flavoring for the flavoring package to the shaped snacks while they are in the tray, re-inserting the tray into the outer package while the shaped snacks are in the tray, and agitating the outer package to distribute the flavoring. The flavoring package may be opened at any time prior to adding the flavoring to the shaped snacks.

The present invention also relates to a kit for flavoring a shaped snack containing: an outer package, a plurality of shaped snacks in the outer package, a flavoring package containing a flavoring therein, and an instruction set. The instruction set contains instructions to: open the outer package, open the flavoring package, apply the flavoring from the flavoring package to the shaped snacks, and agitate the outer package to distribute the flavoring. The flavoring package may be opened at any time prior to adding the flavoring to the shaped snacks.

It has now been found that the present invention may allow a consumer to personally customize a shaped snack in a less messy manner. Surprisingly, it has been found that such a kit and method may provide more even distribution of a flavoring across the shaped snacks without having to agitate to the point of significantly breaking the shaped snacks.

### BRIEF DESCRIPTION OF THE DRAWINGS

The patent or application file contains at least one drawing executed in color. Copies of this patent or patent application publication with color drawings will be provided by the Office upon request and payment of the necessary fee.

While the specification concludes with claims particularly pointing out and distinctly claiming the invention, it is believed that the invention will be better understood from the following description of the accompanying figures in which like reference numerals identify like elements, and wherein:

FIG. 1 is a perspective view of an embodiment of the kit herein during use;

FIG. 2 is a top perspective view of shaped snacks in a tray; and

FIG. 3 is a picture of a coverage grading scale.

The figures herein are not necessarily drawn to scale.

### DETAILED DESCRIPTION OF THE INVENTION

All temperatures herein are in degrees Celsius (° C.) unless otherwise indicated. As used herein, the term “comprising” means that other steps, ingredients, elements, etc. which do not adversely affect the end result can be added. This term encompasses the terms “consisting of” and “consisting essentially of”. All conditions herein are at 20° C., and atmospheric pressure unless otherwise specifically stated. Unless otherwise specifically stated, all ratios, percentages, etc. are by weight of the final snack product. Unless otherwise specifically stated, the ingredients and/or equipment herein are believed to be widely available from multiple suppliers and sources around the world.

As used herein, the term “shaped snack” indicates a man made snack having a predetermined shape, typically a plurality of these shaped snacks will have a regular and uniform 3-dimensional (3D) shape. These snacks may be partially or completely made in a mold and therefore may also be referred to as molded snacks. Examples of such snacks include certain cookies, crackers, potato and crisps, etc. having a regular, predetermined shape. Such shapes are typically sold arranged in a stacked or otherwise aligned manner, either with or without a tray in an outer package.

As used herein, the term “x-based snack” means that snack contains more than 50% by weight ingredients, especially starch, derived from the source, x. So, for example, a “potato-based snack” is a snack which is at least 50% by weight ingredients derived from potatoes. While combinations of base ingredients are useful, any individual snack piece may only be “based” on at most a single ingredient. The Inventors recognize that in some cases, the snack may not be “based” on any one ingredient at all, as no specific ingredient/origin amounts to more than 50% by weight of the snack.

A kit for flavoring a snack, typically a shaped snack, contains an outer package, an optional tray sealed within the outer package, a plurality of shaped snacks arranged within the tray, a flavoring package containing a flavoring therein, and an instruction set. The instruction set contains instructions suggesting the user to open the outer package, remove the tray, if present, from the outer package, typically without yet removing the shaped snacks from the tray, open the flavoring package either before or after the removing the optional tray from the outer package, and apply the flavoring package to the shaped snacks while they, remain in the tray, f present. If a tray is present, then the instructions then suggest to re-insert the tray into the outer package, typically at least partially close the outer package and then agitate the outer package to distribute the flavoring on the shaped snacks. If a tray is not present, then the outer package may typically be at least partially closed and then agitated. Agitation is typically by shaking or rocking the outer container and the contents therein, usually in a gentle manner so as to avoid breaking or otherwise damaging the shaped snacks. The outer package is typically then opened, the tray removed again, and the shaped snacks are consumed.

Surprisingly, it has been found that such a kit and method may provide more even distribution of a flavoring across the shaped snacks. Without intending to be limited by theory, it is believed that the combination of the described particle size, and optionally a tray and the method herein provide a system that allows agitation to distribute the flavoring, while also providing a cushioning effect that reduces breakage of the shaped snacks during agitation. The system herein also provides adequate distribution of flavorings across the shaped snack without having to agitate to the point of increasing breakage of the shaped snacks.

As noted, such a tray is not needed, and is likely wasteful when used with a non-shaped snack, and/or snacks having an irregular shape. Specifically, a plurality of irregularly-shaped snacks would not align evenly in a tray and therefore a tray is superfluous for an irregular (i.e., a non-shaped) snack as it would not typically reduce breakage. Instead, bags of ships or cookies may typically be overfilled with air which acts as an airbag to reduce the effect of impacts and vibrations and thereby reduce breakage. Therefore, in a bag containing an irregular snack, such as regular potato chips, there would be sufficient space between the individual snacks in the outer container (without a tray) to allow one to merely shake the outer package to distribute the flavoring. However, with a shaped snack, if a tray is not provided, then the flavoring may be merely concentrated at the opening of the container, and may not become evenly distributed over all the shaped snacks without dumping out all the shaped snacks from the outer package in a disorderly manner. Obviously, this is discouraged, as it would reduce the aesthetic effect of the shaped snacks, may introduce bacteria and/or other undesirable contaminants to the shaped snacks, the disordered snacks would now likely be very difficult to re-insert into the outer package, and may even increase breakage.

In contrast, if a tray is provided to keep the shaped snacks arranged, then the tray may be easily removed from the outer package, and re-inserted thereinto. Furthermore, such a tray allows the shaped snacks to be completely removed from the outer package. This in turn allows the flavoring to be more evenly spread across all of the shaped snacks, instead of only on the snacks near the opening. The tray may also reduce breaking during agitation.

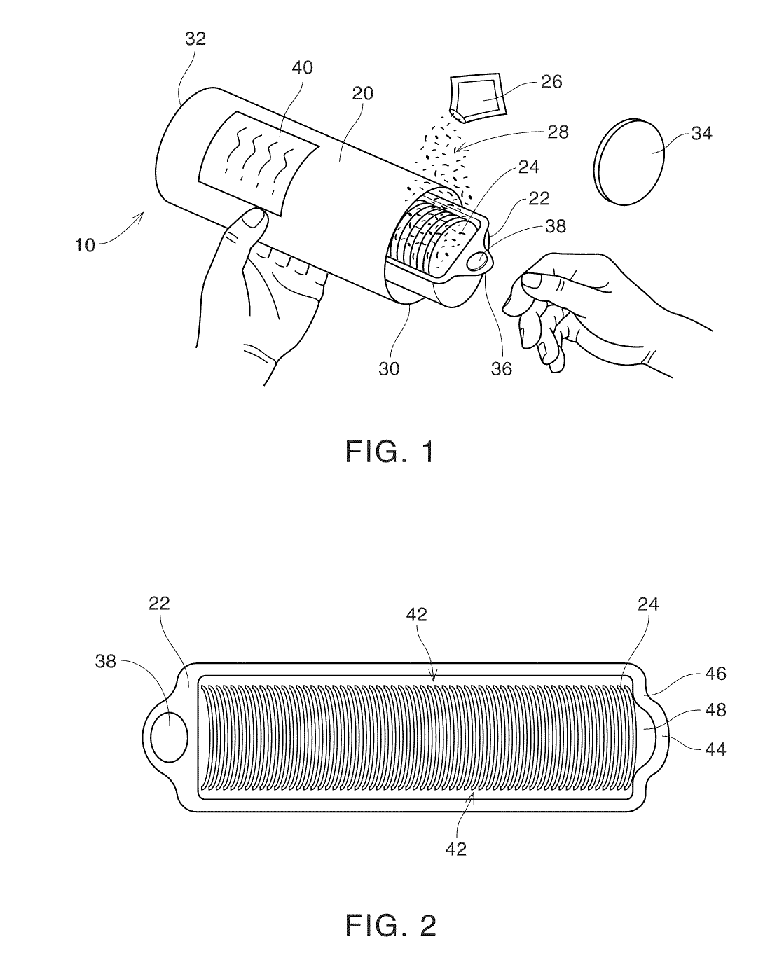

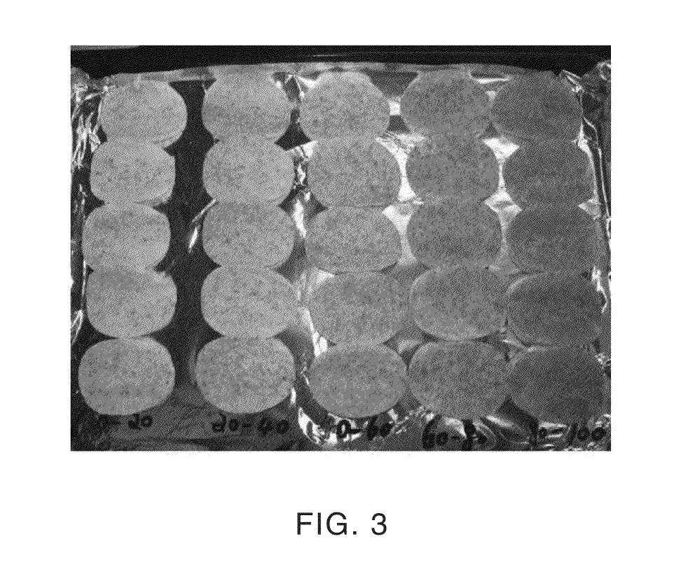

Turning to the Figures, FIG. 1 shows an embodiment of the kit, 10, herein, during use. An outer package, 20, contains a tray, 22, which was previously sealed within the outer package, 20. A plurality of shaped snacks, 24, are arranged in the tray, 22. A flavoring package, 26, is provided and contains a flavoring, 28, therein. In FIG. 1, the tray, 22, has been partially removed from the outer container, 20. the flavoring package, 26, has been opened, and the flavoring, 28, is being applied to the shaped snacks, 24 by sprinkling the flavoring, 28, thereover.

The outer package is typically selected from a bag, a canister, a box and a mixture thereof, or a bag or a canister. In cases where a light and flexible outer package is desired, then a bag such as formed by one or more plastic or metallic films, a biodegradable material, and/or cloth may be preferred. In other cases, where a strong barrier against impact and breakage is more desirable, a canister, such as a cardboard, plastic and/or resin canister may be used. Such outer packages and trays are widely known in the art and available from a variety of packaging suppliers around the world. In an embodiment herein, the outer package is a cardboard canister with laminated layers. In an embodiment herein, the tray is a cardboard tray with laminated layers which may reduce discoloration and/or aesthetic issues due to oil and/or moisture absorption from the shaped snacks. In an embodiment herein, the outer package and/or the tray contains a biodegradable material, such as starch, wood pulp, paper, etc.; or a starch; or cornstarch that is readily decomposable in a landfill and/or compostable to reduce solid wastes.

The shaped snack useful herein may be a savory (i.e., a salty) snack such as a chip, a cracker, a crisp, an extruded snack, popcorn, a pretzel, etc. or a sweet snack such as a candy, a cookie, a biscuit, a processed fruit product, etc. for human or animal consumption, typically for human consumption. As mentioned herein, such shaped snacks typically possess a regular, uniform shape and size, thereby allowing them to be stacked alongside each other in the tray. While such an arrangement reduces breakage and improves aesthetic effect of the snacks, it makes it much more difficult to evenly distribute the flavoring throughout the snacks. Typically, prior to the present invention, such a flavoring would only be able to be distributed to the snacks at either end of the outer package, or across the top of the snacks arranged in the tray.

In order to provide a plurality of shaped snacks which have a similar size and shape, the shaped snacks may be partially or completely made utilizing a mold or other shaped cavity. Such manufacturing processes are well known in the snack art for making cookies, potato crisps, tortilla chips, candies, etc. The shaped snack useful herein may further be based on a variety of raw materials, such as starch, flour, sugar, fruit and/or fruit pulp, etc. In an embodiment herein, the shaped snack is a potato-based shaped snack, a rice-based shaped snack, a wheat-based shaped snack, acorn-bused shaped snack or a fruit-based snack; or a potato-based snack; or a rice-based snack; or a corn-based snack; a wheat-based snack or a fruit-based snack. In an embodiment herein the shaped snack is a crisp such as a potato-based crisp, a rice-based crisp, a wheat-based crisp, or a corn-based crisp; or a potato-based crisp; or a rice-based crisp. In an embodiment herein, the shaped snacks have the same 3D shape and size, but are based on a variety of different ingredients, such as starches. For example, when viewing individual shaped snacks within a single tray. the first snack may be a corn-based snack, the second snack may be a potato-based snack, the third snack may be a rice-based snack, etc.

The shaped snack herein may already containing one or more flavorings, or may be flavoring-free when provided in the outer package, and prior to removal therefrom. Specifically, where a shaped snack already contains a flavoring when provided in the outer package, the flavoring in the flavoring package may be used to increase and/or complement the existing flavoring. In contrast, where a shaped snack is provided in the outer package without a specific flavoring, then the flavoring in the flavor package may be used to provide virtually all, or all, of the shaped snack's flavor.

The flavoring package herein holds the flavoring physically separate from the snack until the kit is ready for use. The flavoring package may be contained within the outer package, or outside the outer package such as being affixed thereto. The flavoring package may be made of any convenient material, such as a plastic, paper, a foil, and a mixture thereof. Typically, the flavoring package is a paper or film packet.

In an embodiment herein, the flavoring package is sold together with the outer package, either, as part of the outer package, within the outer package, and/or attached to the outer package. However, the method herein specifically encompasses situations where the flavoring package is sold or provided separately from the outer package.

The flavoring in the flavoring package may be a sweet flavoring, a spicy flavoring, a bitter flavoring, an umami flavoring, and/or a salty flavoring, as desired. The flavoring may often be a salty and/or umami flavoring for a savory snack, or a sugary flavoring for a sweet snack. The flavoring may be the same as that already on the shaped snack, as in a case where a “flavor boost” is desired. Alternatively, any flavoring on the shaped snack may be different from that in the flavoring package such as where the user seeks a mixture of different flavorings to create a complementary flavor. The flavoring may be a liquid flavoring, or a particulate flavoring, and is typically a particulate flavoring. The Inventors specifically recognize that when sealed into the outer package, the snack itself may already possess the same or a different flavoring, or in some cases may not contain significant amounts of flavoring.

In an embodiment herein, the flavoring is a spicy flavoring, such as wasabi, horseradish, cayenne pepper, jalapeno pepper, habanero pepper, etc., especially packed in an airtight flavoring package, typically with an inert gas, as such flavorings tend to quickly oxidize and therefore lose their spiciness if added to the shaped snack during the typical production process. Furthermore, such spices may be difficult to add in an industrial production process, but which may be easy to add in a small-scale manual process. Without intending to be limited by theory, it is believed that the present invention specifically enables such flavorings to be maintained in an unoxidized state during production, shipping and storage, and to provide the desired spiciness during consumption of the snack.

One or more flavorings in one or more flavoring packages are useful herein. In an embodiment herein, a plurality of flavoring packages with different flavorings are employed to provide complementary flavors on different, or the same shaped snacks. For example, a tomato flavoring on some chips near one end of the tray, and a cheese flavoring for chips near the other end of the tray. In another embodiment, the tomato and cheese flavorings are separately added to all of the shaped snacks on the same tray.

Without intending to be limited by theory, it is believed that some ingredients may not be very oil-compatible or may deteriorate with long-term exposure to oils in foods. the present invention also allows the addition of flavorings which are separated from any oil on the shaped snack and therefore may allow greater shelf life, better taste, a wider range of materials and flavorings to increase formulation flexibility, etc.

Especially in the case of a shaped potato-based crisp, typically a salty shaped snack, it has been surprisingly found that especially preferred coverage of the shaped snack may be achieved when the flavoring has a particle size distribution where at least about 35%, or from about 35% to about 100%, or from about 37% to about 90%, or from about 40% to about 85%, by weight of the flavoring in the flavoring package, of the flavoring particles have a particle size of from about 46μ to about 106μ. Without intending to be limited by theory, it is believed that this particle size especially allows the flavoring to more evenly distribute across the shaped snacks, especially a potato-based shaped crisp as compared to other particle sizes. If the particle size is too large, then the Inventors found that too much of the flavoring falls to the bottom of the tray and does not adhere to the shaped snacks, and/or does not get into the spaces between individual shaped snacks. If the particle size is too small, then the flavoring is too dusty and again, the flavoring may drift in the air of the outer package instead of settling onto the shaped snack. In some cases where the flavoring particle size is too small, the flavoring may actually cover the snack too much, indicating to the consumer that there is an unacceptably high level of flavoring on the shaped snack. This may, in some cases imply to the consumer that the snack may be too salty, and/or too sweet depending on the nature of the flavoring and the snack.

In an embodiment herein, especially where the shaped snack is a potato-based shaped snack, it has been surprisingly found that the kit and method herein are especially effective when the flavoring has a certain particle size distribution in relation to the weight of shaped snacks (prior to addition of flavoring). Specifically, in an embodiment herein, the flavoring has a weight ratio of particles having a particle size of from about 46μ to about 106μ:weight of shaped snacks of from about 1:120 to about 1:10, or from about 1:100 to about 1:15, or from about 1:80 to about 1:20. The weight of shaped snacks is determined prior to the addition of the flavoring in the flavoring package. However, this weight includes any flavoring already present on the shaped snack when the snacks are first removed from the outer package, according to the method herein. Without intending to be limited by theory, it is believed that such a ratio of flavoring to shaped snack provides a good balance between coverage and flavor, without appearing to be too salty of too sweet. Furthermore, it is believed that such a ratio provides the optimum coverage of a potato-based shaped snack with the kit and method herein.

In an embodiment herein, the flavoring contains less than about 25%, or from about 0% to about 25%, or from about 3% to about 23%, or from about 5% to about 20% salt (NaCl). While salt may be desirable in salty snacks, flavorings having too much salt are believed to be less preferred from consumer preference and health points of view.

The flavoring useful herein is available upon request and/or by order from a variety of sources, such as International Flavors & Fragrances, Inc., New York, N.Y., U.S.A.; Kerry Group, plc, Tralee, Co. Kerry, Ireland; Griffith Laboratories, Alsip, Ill., U.S.A.; and others.

In FIG. 1, the outer package, 20, is a canister with an open end, 30, and a closed end, 32. Also present is a lid, 34, which may snap onto and repeatedly seal the open end, 30, of the outer package, 20, during shipment, agitation, and storage. Once the lid, 34, is removed, and any additional optional seals are broken or removed, the tray, 22, may be partially, or completely slid out of the outer package, 20. The tray, 22, contains an optional tab, 36, with a grip, 38, which allows the user to easily withdraw the tray, 22, from the outer package, 20.

The lid, 34, is typically repeatedly removable and re-attachable so that the canister may be resealed for agitation, storage, etc. The lid may be made of any compatible material, such as plastic, or resin. The lid is often secure when re-attached, such that lid removal requires a specific effort to do so. This prevents accidental removal during the agitating step of the method herein. In an embodiment herein, the lid is used to re-seal the outer package after re-inserting the tray into the outer package, and before agitating the outer package to distribute the flavoring.

In the embodiment of FIG. 1, an instruction set, 40, is printed directly onto the outer package, 20, and contains instructions describing how to use the kit and perform the flavoring method herein. In another embodiment, the instruction set is provided separately from the outer package, such as on a store display, on a separate sheet inside the outer package, etc. Such an instruction set may provide the instructions verbally, in written form, and/or graphically. In an embodiment herein the instruction set is provided graphically with minimal words.

FIG. 2 shows a top view of the tray, 22, containing a plurality of shaped snacks, 24, here, specifically shaped potato crisps. Also seen in FIG. 2 are the spaces, 42, between the shaped snacks, 24. As the flavoring (see FIG. 1 at 28) is sprinkled over the top of the potato crisps, some of the flavoring falls within the spaces, 42, between the chips. Such spaces are typically about 0.25 mm to about 1 mm wide, and may be relatively evenly distributed throughout the stack of crisps. The tray, 22, catches the flavoring which falls all the way through the spaces, 42, no as to reduce messiness. The tray is then re-inserted into the outer package (see FIG. 1 at 20) for the agitating step in the process herein.

To further protect the shaped snacks, 24, from impacts and to reduce breakage, the tray, 22, typically contains a cushion, 44, at one end, 46. The cushion, 44, is formed such that an open space, 48, exists between the tray, 22, and the shaped snack, 24. This allows the cushion, 44, to deform so as to absorb shocks and impacts. However, because the cushion, 44, has space to deform before touching the shaped snacks, 24, the impact can be absorbed by the tray without transmitting the impact force directly to the shaped snack, 24. This significantly reduces breakage of the shaped snacks, 24, especially during agitation according to the method herein. In an embodiment herein, the tray may contain a plurality of cushions, such as at opposite ends of the tray, on the bottom, and/or on the sides.

### Particle Size Measurement

The flavoring particle size herein is measured by sifting a given flavoring through a series of meshes and collecting the flavoring remaining on each mesh. Specifically, a Tyler RO-TAP Sieve shaker, model #RX-29-10, from Sepor, Inc. of Wilmington, Calif., USA, is a 9-sieve shaking machine with the following properties:

| | | range of particles |
|---|---|---|
| Sieve # | opening (μ) | remaining on mesh (μ) |
| 20 | 850 | >850 |
| 30 | 600 | 601-850 |
| 40 | 425 | 426-600 |
| 50 | 300 | 301-425 |
| 70 | 212 | 213-300 |
| 100 | 150 | 151-212 |
| 140 | 106 | 107-150 |
| 200 | 75 | 76-106 |
| 325 | 45 | 46-75 |
| Pan | 0 | <46 |

To determine the weight percentage of seasoning having a particle size from about 46μ to about 106μ, a pre-weighed amount (e.g., 100 g) of flavoring is separated according to the above sieves, and then the portions remaining on the 200 and 325 sieves are collected and combined. The percentage is therefore:

$$\% particles = \frac{( g remaining on 200 sieve + g remaining on 325 sieve ) * ( 100 )}{( g total flavoring prior to sieving )}$$

The weight of the flavoring remaining on the 200 and 325 sieves may also be recorded to determine the weight ratio of flavoring having a particle size of from about 46μ to about 106μ:weight of shaped snacks.

It has also surprisingly been found that the color pigment(s) in the flavorings seem to be remarkably uniformly coating the different particle sizes, as the colors are relatively uniform across all samples taken from on top of the various meshes.

### Coverage Rating

The amount of the surface area of a shaped snack, and especially a shaped crisp, covered by a flavoring is directly related to the acceptance of the shaped snack by consumers. Too little surface area covered indicates to the consumer that the flavor of the shaped snack is too weak, whereas too much surface area covered indicates that the flavor is too strong. Therefore, the present invention is directed towards an optimized method and kit for providing the optimum coverage of a shaped snack by a flavoring. Shaped snacks, are subjected to the method herein, and then their appearance is visually graded and compared to a standard reference shown in the picture below. This standard reference indicates 0-20% coverage in the 1^{st} column, 20-40% coverage in the 2^{nd} column, 40-60% coverage in the 3^{rd} column, 60-80% overage in the 4^{th} column, and 80-100% coverage in the 5^{th} column.

Consumer research shows that shaped crisps corresponding to the 40-80% in the 3^{rd} and 4^{th} columns, and especially the 60-80% coverage shown in the 4^{th} column are significantly preferred over shaped crisps corresponding to the other columns.

To conduct the coverage test, an outer package formed of a cardboard canister is provided containing a tray snugly sealed therein, the tray contains 40 g of shaped potato-based crisps therein. A flavoring package containing 2.3 g of flavoring is provided. To make the test easier to judge, a flavoring containing a dark colored pigment, such as red may be used to more easily judge the covering rating. The canister's lid is opened and the tray containing the crisps is removed completely from the outer package. The flavoring package is opened, and all of the flavoring is poured evenly across the top of the crisps. The tray, including the crisps with the flavoring thereupon, is re-inserted into the canister and the lid is closed. The canister is then rolled 6 complete revolutions in 10 seconds and then tumbled end-over-end 6 complete times in another 10 seconds. The lid is then removed and the tray containing the crisps is then removed from the canister, and the crisps are judged for their coverage as compared to the standard references, and their column numbers (1 to 5) are averaged to find the average coverage score for that sample. An average score of about 2 to about 4 indicates a sample with acceptable coverage, or even a score of about 2.5 to about 3.5 for preferred shaped snacks.

A lower standard deviation (ⁿ⁻¹) indicates a more consistent coverage of the shaped snacks by the flavoring, and is therefore preferred. In contrast, a larger standard deviation indicates that the coverage is not uniform and is undesirable.

### Example 1

A 2.3 g package of a particulate salty flavoring having 40% particles from 46-106μ is prepared and used according to the invention herein on 40 g of shaped potato-based crisps as seen in FIG. 2. A canister, as in FIG. 1 is provided as well. A tray is also provided according to FIG. 2 and is used as per the method herein. The coverage test shows an average score of 2.4 with a standard deviation of 0.7 (indicating that the coverage of the crisps is relatively even). Importantly, the coverage of the end crisps and the middle crisps is relatively similar.

In a comparative sample where the tray is not present, the identical flavoring is simply emptied into the end of the canister and the lid is replaced. Agitation is identical. The coverage test shows an average score of 1.8, and a standard deviation of 1.2 (indicating that the coverage of the crisps is not very uniform). In addition, it is found that the flavoring is concentrated on the crisps at either end of the canister, while those crisps in the middle have very little flavoring thereupon.

From this it is concluded that the addition of a tray provides significant benefits.

### Example 2

A particle size study is conducted showing that flavoring particles in the range of from 46-106μ show significantly better coverage ratings of around 3, as compared to flavoring particles having larger or smaller particle sizes. This data is consistent across a variety of different flavorings from a variety of different manufacturers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for flavoring a shaped snack comprising the steps of:
A. providing an outer package;
B. providing a tray sealed inside the outer package;
C. providing a plurality of shaped snacks arranged in the tray;
D. providing a flavoring package comprising a flavoring therein;
E. opening the outer package;
F. removing the tray from the outer package;
G. opening the flavoring package;
H. applying the flavoring from the flavoring package to the shaped snacks while the shaped snacks are in the tray;
I. re-inserting the tray into the outer package wherein the shaped snacks are in the tray; and
J. agitating the outer package to distribute the flavoring,
wherein opening the flavoring package may occur at any time prior to adding the flavoring to the shaped snacks.

2. The method according to claim 1, wherein the shaped snack is selected from the group consisting of a chip, a cracker, a crisp, a pretzel, a candy, a cookie, a biscuit, a processed fruit product and a mixture thereof.

3. The method according to claim 1, wherein the flavoring is a salty flavoring.

4. The method according to claim 1, further comprising the step of re-sealing the outer package after the re-inserting step (I), and before the agitating step (J).

5. The method according to claim 1, wherein the flavoring is a particulate flavoring.

6. The method according to claim 2, wherein the shaped snack is a crisp selected from the group consisting of a potato-based crisp, a rice-based crisp, or a corn-based crisp.

7. The method according to claim 6, wherein the flavoring is a particulate, salty flavoring having, by weight of the flavoring, at least 35% particles with a particle size from about 46μ to about 106μ.

8. The method according to claim 6, wherein the flavoring is a particulate, salty flavoring, and wherein the weight ratio of flavoring having a particle size from about 46μ to about 106μ to the weight of shaped snacks is from about 1:120 to about 1:10.

9. The method according to claim 1, wherein the flavoring comprises less than about 25% salt.

10. A kit for flavoring a shaped snack comprising:
A. an outer package;
B. a plurality of shaped snacks arranged in the outer package;
C. a flavoring package comprising a flavoring therein; and
D. an instruction set comprising instructions to:
i. open the outer package;
ii. open the flavoring package;
iii. apply the flavoring from the flavoring package to the shaped snacks; and
iv. agitate the outer package to distribute the flavoring,
wherein opening the flavoring package may occur anytime before applying the flavoring to the shaped snacks.

11. The kit according to claim 10, further comprising a tray sealed in the outer package, wherein the shaped snacks are arranged in the tray, and wherein the instruction set further comprises the instructions to:
i. remove the tray from the outer package after opening the outer package;
ii. apply the flavoring from the flavoring package to the shaped snacks wherein the shaped snacks are in the tray;
iii. re-insert the tray into the outer package wherein the shaped snacks are in the tray.

12. The kit according to claim 10, wherein the flavoring is a particulate, salty flavoring having, by weight of the flavoring, at least 35% particles with a particle size from about 46μ to about 106μ.

13. The kit according to claim 10, wherein the flavoring is a particulate, salty flavoring, and wherein the weight ratio of flavoring having a particle size from about 46μ to about 106μ to the weight of shaped snacks is from about 1:120 to about 1:10.

14. The kit according to claim 10, wherein the outer package is selected from the group consisting of a bag, a canister, a box, and a combination thereof.

15. The kit according to claim 14, wherein the outer package is a canister.

16. The kit according to claim 10, wherein the flavoring comprises less than about 25% salt.

17. The kit according to claim 10, comprising a plurality of separate flavoring packages.
